(19) United States
(12) Patent Application Publication
(10) Pub. No.: US 2017/0151847 A1
(43) Pub. Date: Jun. 1, 2017

(54) Constant Rail Wheel Pressure Apparatus for a Railgear Guide Unit

(71) Applicant: G&B Specialties, Inc., Berwick, PA (US)

(72) Inventor: Anthony M. Letukas, Dallas, PA (US)

(21) Appl. No.: 14/953,899

(22) Filed: Nov. 30, 2015

(51) Int. Cl. B60F 1/04; B60F 1/00; B61D 15/00

(52) U.S. Cl. CPC B60F 1/04; B61D 15/00; B60F 1/005

(57) ABSTRACT

A railgear guide unit assembly for a road vehicle comprises a pair of rail wheels coupled to an axle, a first pair of pivotal links, and a second pair of pivotal links, wherein both pairs of pivotal links are coupled to the axle at one end. The assembly further comprises a pair of railgear pressure mechanisms, wherein the railgear pressure mechanisms each comprise an outer guide assembly, an inner guide translatable within the outer guide assembly, and a spring coupled to a first end of the inner guide to provide a compressive force on the inner guide. One end of each of the pair of pivotal links is coupled to a respective inner guide such that a movement of the inner guides of respective railgear pressure mechanisms corresponds to a movement of the respective pair of pivotal links.

### BACKGROUND OF THE DISCLOSURE

Field of the Disclosure

The present disclosure relates generally to “hi-rail” or railgear guide unit assemblies that enable conventional roadway vehicles to travel upon a railway track. More particularly, the present disclosure relates to a railgear guide unit assembly having a rail wheel pressure adjustment mechanism configured to provide uniform, constant rail wheel pressure on the tracks in the event of a deviation between the height of the vehicle's tire tread and the rail wheel's tread due to irregularities in the track running surface.

Description of Related Art

Hi-rail, or railgear guide unit assemblies, refer to retractable railway wheels that are attachable to standard roadway vehicles so as to enable those vehicles to effectively travel along conventional railroad tracks. Vehicles equipped with such railgear guide unit assemblies are commonly used as maintenance vehicles or as track inspection vehicles due to their mobility on both standard roadways and railroad tracks.

Conventionally, vehicles equipped with railgear guide unit assemblies utilize both a front assembly and a rear assembly. The front assembly is often configured to lift the vehicle's front tires upward and out of contact with the track surface, as the front wheels are generally not the vehicle's driven wheels. Conversely, the rear assembly is generally configured to at least partially lift a rear portion of the vehicle away from the track surface, while still maintaining some contact between the vehicle's rear tires and the track surface, thereby enabling the vehicle to be propelled along the railroad tracks. To accomplish this lift, many rear railgear guide unit assemblies utilize multiple hydraulically-driven piston assemblies that are pivotally coupled between an axle holding the rear rail wheels and a base plate affixed to the vehicle's frame. Often, the pivotal coupling between the piston assemblies, axle, and base plate results in a scissor-lift type configuration, with the railgear guide unit assembly being able to extend and retract along a single vertical plane. When the rear railgear guide unit is desired to be in contact with the track surface, the piston assemblies are hydraulically driven to lower the rear rail wheels. On the other hand, when the vehicle is to be removed from the track surface and/or driven on a standard roadway, the piston assemblies are hydraulically driven to vertically retract the rear rail wheels away from the track surface.

As a vehicle equipped with railgear guide unit assemblies travels along a track surface, it may encounter situations where the vehicle's rear tires become unloaded or otherwise rise above the track surface. Such a situation may occur when the rear tires come into contact with railway switches, “frogs”, uneven crossings, or any other object along the rail line that would cause the tires to be lifted above the track surface. If the rear tires lift above the track surface for any reason, the tread of the rear rail wheels may lose contact with the track surface, thereby increasing the risk of possible derailment of the vehicle.

As is illustrated in FIGS. 1A-1C, at least one known rear railgear guide unit assembly has attempted to address the above-described concerns regarding loss of contact between rail wheels and the track surface. Referring to FIG. 1A, a rear railgear guide unit assembly 100 in accordance with the prior art is illustrated. Railgear guide unit assembly 100 comprises a base plate 102 and respective brackets 104a, 104b for mounting the railgear guide unit assembly 100 to a rear portion of the vehicle frame. Respective right and left rear rail wheels 106a, 106b are rotationally coupled to an axle 108. Respective lower linkage members 110a, 110b are pivotally coupled at a first end to axle 108 about pivot pins 112a, 112b, and pivotally coupled at a second end to upper linkage members 114a, 114b about pivot pins 116a, 116b. Upper linkage members 114a, 114b are, in turn, pivotally coupled to base plate 102 about pivot pins 118a, 118b. A pair of hydraulic cylinders 120a, 120b having respective hydraulically-driven pistons 122a, 122b are pivotally coupled about pivot pins 126a, 126b on upper linkage members 114a, 114b at a first end, and pivotally coupled about pivot pins 124a, 124b on axle 108 on a second end thereof As is known in the art, this hydraulically-driven configuration enables the rail wheels 106a, 106b to be extended or retracted dependent upon the desired position of the rear railgear guide unit 100. While not shown, it is to be understood that the respective linkage members 110a, 110b, and 114a, 114b may be locked in a desired extended or retracted position (e.g., via a pin or other locking mechanism) so as to prevent undesirable movement or pivoting of the components of rear railgear guide unit 100.

Referring to FIG. 1B, a portion A of rear railgear guide unit assembly 100 in a normal operating condition is shown. When rear rail wheel 106b is in contact with a track surface in a deployed position, pivot pin 112b is pivotally coupled to lower linkage member 110b at an upper end of a slot 128b formed within lower linkage member 110b. Thus, the weight of the vehicle versus the counteractive force of rail wheel 106b maintains pivot pin 112b at the upper end of slot 128b. While not shown, it is to be understood that the opposite side of rear railgear guide unit assembly 100 operates in an identical manner.

FIG. 1C, on the other hand, illustrates a condition where rear rail wheel 106b is unloaded due to, for example, the vehicle's rear tire(s) lifting above the track surface. As FIG. 1C shows, railgear guide unit assembly 100 is configured to enable pivot pin 112b on axle 108 to slide downward within slot 128b, thereby allowing rear rail wheel 106b to move downward a corresponding amount during unloaded conditions. The amount of translational movement allowable within slot 128b could be, for example, 1 inch. With such a configuration, it is possible for rear rail wheel 106b to maintain some contact with the track surface even if the vehicle's rear tire(s) are lifted above the track surface. However, the configuration illustrated in FIGS. 1A-1C relies upon the weight of axle 108 and gravity to keep rail wheel 106b in contact with the track surface. If pin 112b does not slide freely within slot 128b, axle 108 will not drop, and rail wheel 106b could potentially lift out of contact with the track surface, possibly causing derailment. Additionally, the slotted engagement between the axle and respective lower linkage members may allow the axle and rail wheels to move within the railgear guide unit assembly when the assembly is not in a deployed position (i.e., during standard roadway travel), thereby causing component wear and excessive noise.

Accordingly, it is desirable to provide a railgear guide unit assembly that is capable of providing a constant, uniform downward force on the rail wheels, either independently or in tandem, so as to accommodate differences in height of the vehicle tire tread and rail wheel tread due to irregularities in the track surfaces.

### SUMMARY OF THE DISCLOSURE

Generally, it is an object of the present disclosure to provide a railway guide unit assembly and method that overcomes some or all of the above-described deficiencies of the prior art.

A preferred, but non-limiting, aspect of the disclosure includes a railgear guide unit assembly for a road vehicle, the assembly comprising a base plate for mounting the assembly to at least one frame member of the vehicle, an axle, a first rail wheel rotatably mounted on a first end of the axle, and a second rail wheel rotatably mounted on a second end of the axle. The assembly further comprises a first pair of pivotal links having a first end and a second end, and a second pair of pivotal links having a first end and a second end, wherein the second end of both the first pair of pivotal links and the second pair of pivotal links is pivotally coupled to the axle. Additionally, the assembly comprises a first railgear pressure mechanism coupled to the base plate, wherein the first railgear pressure mechanism is further coupled to the first end of the first pair of pivotal links and is configured to provide a constant force thereon. The assembly also comprises a second railgear pressure mechanism coupled to the base plate, wherein the second railgear pressure mechanism is further coupled to the first end of the second pair of pivotal links and is configured to provide a constant force thereon.

Another preferred, but non-limiting, aspect of the disclosure includes a method of operating a roadway vehicle on railway tracks, the vehicle having at least a rear pair of roadway tires. The method comprises providing a railgear guide unit assembly having a base plate, an axle, a pair of rail wheels, a first pair of pivotal links coupled to the axle at a first end, and a second pair of pivotal links coupled to the axle at a first end. The method further comprises providing a first railgear pressure mechanism, the first railgear pressure mechanism having a translatable inner guide coupled to a compression spring at a first end thereof and coupled to a second end of the first pair of pivotal links at a second end thereof, and providing a second railgear pressure mechanism, the second railgear pressure mechanism having a translatable inner guide coupled to a compression spring at a first end thereof and coupled to a second end of the second pair of pivotal links at a second end thereof. Additionally, the method comprises attaching the railgear guide unit assembly to the vehicle at a location near the rear pair of tires, and lowering the pair of rail wheels of the railgear guide unit assembly onto the railway tracks such that the rear pair of tires propel the vehicle.

Another preferred, but non-limiting, aspect of the disclosure includes a railgear guide unit assembly for a road vehicle, the assembly comprising a base plate for mounting the assembly to a vehicle frame, an axle, and a pair of rail wheels mounted for rotation about opposite ends of the axle. The assembly also comprises a first set of pivotal links having a first end and a second end, and a second set of pivotal links having a first end and a second end, wherein the second end of both the first set of pivotal links and the second set of pivotal links is coupled to the axle. Furthermore, the assembly comprises a first railgear pressure mechanism and a second railgear pressure mechanism, wherein each of the first railgear pressure mechanism and the second railgear pressure mechanism comprises an outer guide assembly, an inner guide configured for axial translation within the outer guide assembly, the inner guide having a first end and a second end, and a spring coupled to the first end of the inner guide and configured to provide a compressive force on the inner guide. The first end of the first set of pivotal links is coupled to the second end of the inner guide of the first railgear pressure mechanism, and the first end of the second set of pivotal links is coupled to the second end of the inner guide of the second railgear pressure mechanism.

These and other features and characteristics of the present disclosure, as well as the methods of operation and functions of the related elements of structures and the combination of parts and economies of manufacture, will become more apparent upon consideration of the following description and appended claims with reference to the accompanying drawings, all of which form a part of the specification, wherein like reference numerals designate corresponding parts in various figures. It is to be expressly understood, however, that, the drawings are for the purpose of illustration and description only and are not intended as a definition of the limits of the disclosure. As used in the specification and claims, the singular form of “a,” “an,” and “the” include plural referents unless the context clearly dictates otherwise.

### BRIEF DESCRIPTION OF THE DRAWINGS

FIG. 1A is a rear view of a known railgear guide unit assembly;

FIG. 1B is a detail view of detail A in FIG. 1A of the railgear guide unit assembly in a first configuration;

FIG. 1C is a detail view of detail A of FIG. 1A of the railgear guide unit assembly in a second configuration;

FIG. 2 is a rear view of a railgear guide unit assembly;

FIG. 3 is a cross-sectional view along line B-B in FIG. 2 of a portion of the railgear guide unit assembly;

FIG. 4 is a rear view of the railgear guide unit assembly in a first configuration;

FIG. 5 is a side view of the railgear guide unit assembly in the first configuration shown in FIG. 4;

FIG. 6A is a rear view of a railgear pressure mechanism of the railgear guide unit assembly in the first configuration shown in FIG. 4;

FIG. 6B is a cross-sectional view along line C-C in FIG. 6A of the railgear pressure mechanism;

FIG. 7 is a rear view of the railgear guide unit assembly in a second configuration;

FIG. 8 is a side view of the railgear guide unit assembly in the second configuration shown in FIG. 7;

FIG. 9A is a rear view of a railgear pressure mechanism of the railgear guide unit assembly in the second configuration shown in FIG. 7;

FIG. 9B is a cross-sectional view along line D-D in FIG. 9A of the railgear pressure mechanism; and

FIG. 10 is a rear view of the railgear guide unit assembly in a third. configuration.

### DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary aspects of the disclosure. Hence, specific dimensions and other physical characteristics related to the aspects disclosed herein are not to be considered as limiting.

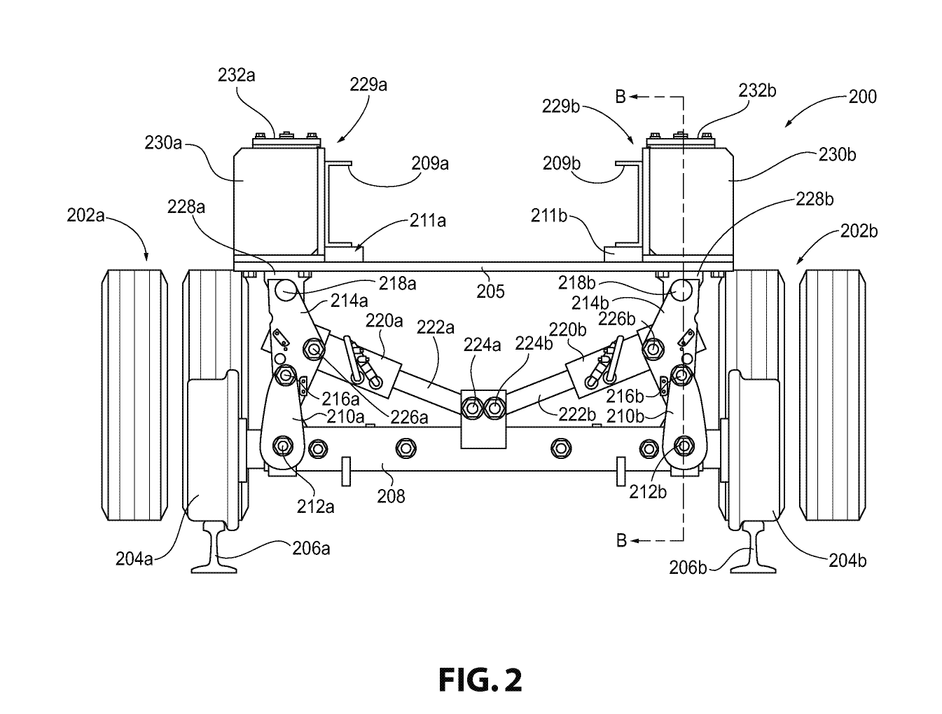

Referring to FIG. 2, a railgear guide unit assembly 200 is illustrated. Railgear guide unit assembly 200 is shown installed on a standard roadway vehicle having rear tires 202a, 202b. Generally, railgear guide unit assembly 200 is installed to the rear of tires 202a, 202b, but could be installed elsewhere on the vehicle in the vicinity of tires 202a, 202b. Shown in a deployed position (e.g., in contact with the track surfaces), railgear guide unit assembly 200 comprises a base plate 205 for mounting the railgear guide unit assembly 200 to vehicle frame portions 209a, 209b. Spacers 211a, 211b between base plate 205 and frame portions 209a, 209b may or may not be used to obtain optimal positioning of assembly 200 on the vehicle. Respective right and left rear rail wheels 204a, 204b are rotationally coupled to an axle 208, with rail wheels 204a, 204b shown as being in contact with the top surface of respective tracks 206a, 206b.

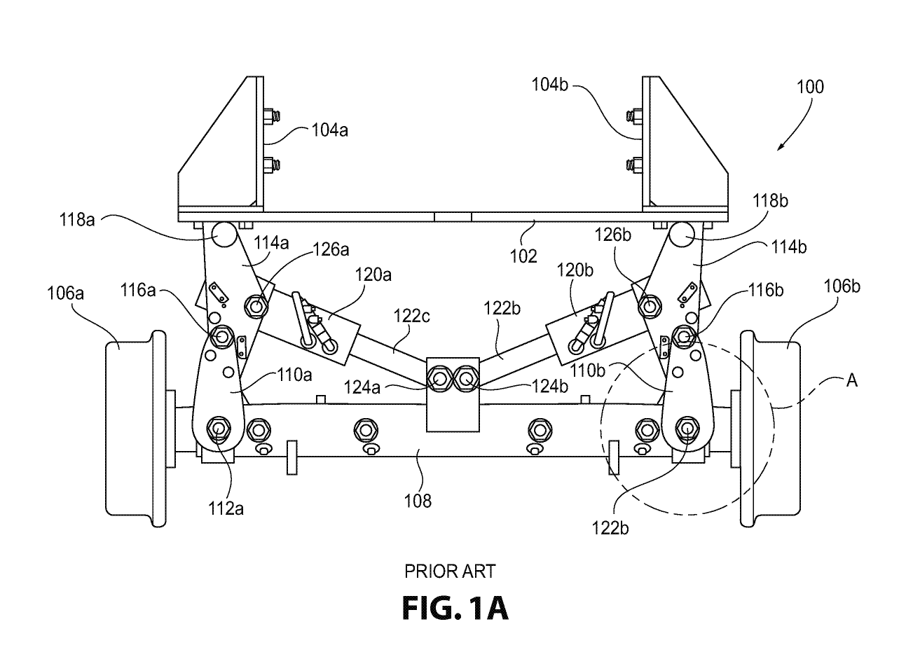

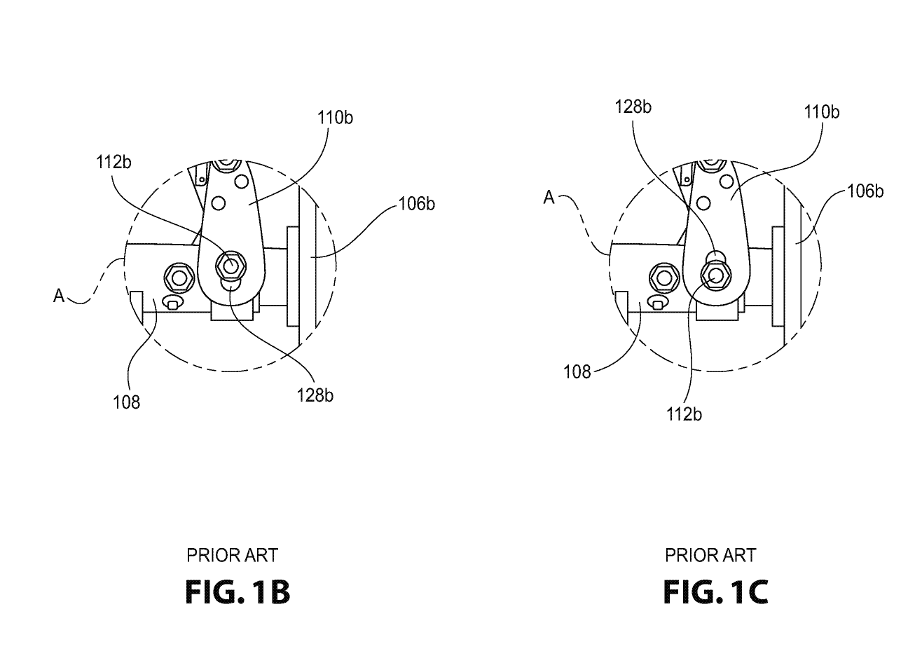

Similar to railgear guide unit assembly 100 described above with respect to FIG. 1, assembly 200 comprises respective lower linkage members 210a, 210b which are pivotally coupled at a first end to axle 208 about pivot pins 212a, 212b, and pivotally coupled at a second end to upper linkage members 214a, 214b about pivot pins 216a, 216b. Upper linkage members 214a, 214b are, in turn, pivotally coupled to respective inner guide assemblies 228a, 228b about pivot pins 218a, 218b, as will be described further hereinbelow. While a total of four linkage members are shown and described herein, it is to be understood that utilizing more or fewer linkage members is also possible. A pair of hydraulic cylinders 220a, 220b having respective hydraulically-driven pistons 222a, 222b are pivotally coupled about pivot pins 226a, 226b on upper linkage members 214a, 214b at a first end thereof, and pivotally coupled about pivot pins 224a, 224b on axle 208 at a second end thereof. Such a hydraulically-driven configuration enables the rail wheels 204a, 204b to be extended or retracted dependent upon the desired position of the rear railgear guide unit assembly 200. Also, while not shown, it is to be understood that the respective linkage members 210a, 210b, and 214a, 214b may be locked in a desired extended or retracted position (e.g., via a pin or other locking mechanism) so as to prevent undesirable movement or pivoting of the components of rear railgear guide unit assembly 200.

Unlike railgear guide unit assembly 100 described above with respect to FIG. 1, railgear guide unit assembly 200 does not comprise a slotted engagement between pivot pins 212a, 212b and axle 208 to account for deviations in vehicle tire and rail wheel heights. Instead, in accordance with an aspect of the present disclosure, railgear guide unit assembly 200 comprises a pair of railgear pressure mechanisms 229a, 229b configured to provide a constant, uniform downward pressure to each rail wheel 204a, 204b, even in instances of deviation between the height of vehicle tires 202a, 202b and the normal surface height of tracks 206a, 206b.

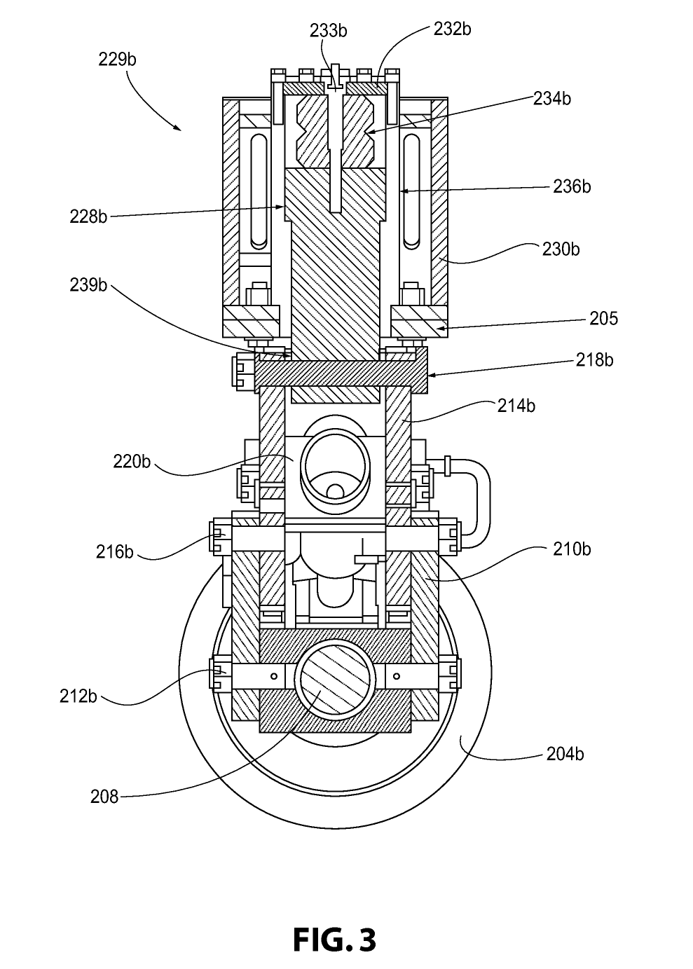

FIG. 3 is a cross-sectional view of railgear pressure mechanism 229b and other components of railgear guide unit assembly 200 about section B-B of FIG. 2. While not illustrated, it is to be understood that the operation of railgear pressure mechanism 229a and associated components is substantially identical to that of railgear pressure mechanism 229b. As previously described, railgear guide unit assembly 200 comprises a rail wheel 204b rotationally coupled to an axle 208, with respective linkage members 210b and 214b pivotally coupled thereto to form a scissor-type extension mechanism. However, unlike conventional railgear guide units, one end of linkage member 214b is pivotally coupled to railgear pressure mechanism 229b, which allows for constant, uniform downward pressure to be applied to rail wheel 204b.

More specifically, railgear pressure mechanism 229b comprises a housing 230b mounted above base plate 205. Housing 230b holds a fixed outer guide assembly 236b, wherein outer guide assembly 236b is configured to slidably retain an inner guide 228b therein. Inner guide 228b is configured to axially translate a restricted distance within outer guide assembly 236b. Inner guide 228b extends beyond and below housing 230b and through base plate 205, wherein a distal end of inner guide 228b is configured to be pivotally coupled to upper linkage 214b via a pivot pin 218b extending through an inner guide bushing 239b of inner guide 228b. At a proximal end of inner guide 228b, a spring 234b is mounted thereto via a pin or threaded rod 233b. Spring 234b may be any appropriate spring-type device, such as a rubber spring, a coil spring, etc. An outer guide cap 232b is mounted to outer guide assembly 236b, wherein outer guide cap 232b is configured to compress spring 234b between outer guide cap 232b and inner guide 228b so as to pre-load inner guide 228b with approximately 1500-2000 lbs. of force. This pre-loaded force exists even when inner guide 228b is at its fullest extension, with rail wheel 204b out of contact with the track surface and/or railgear guide unit assembly 200 in an undeployed position.

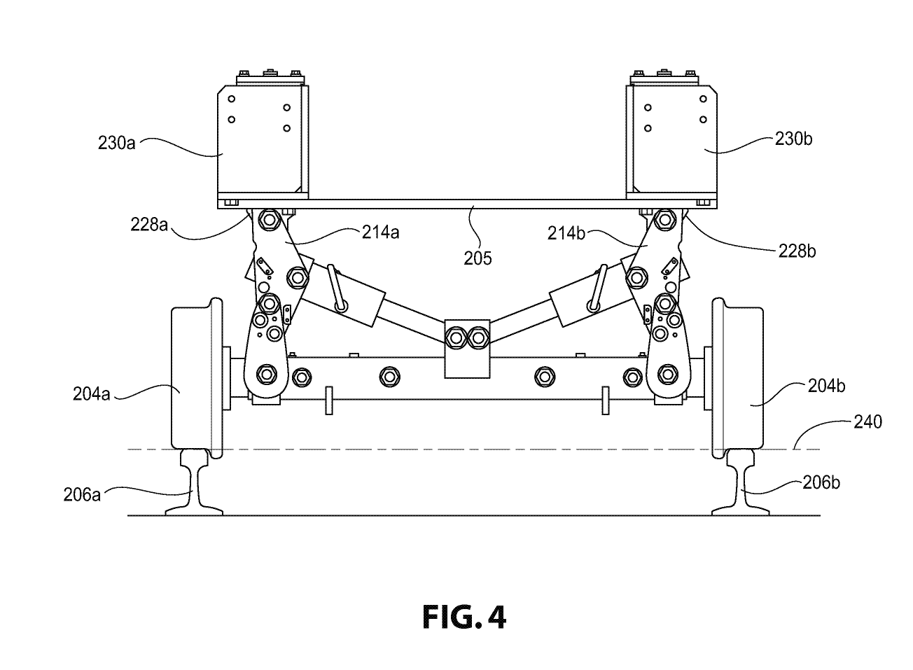

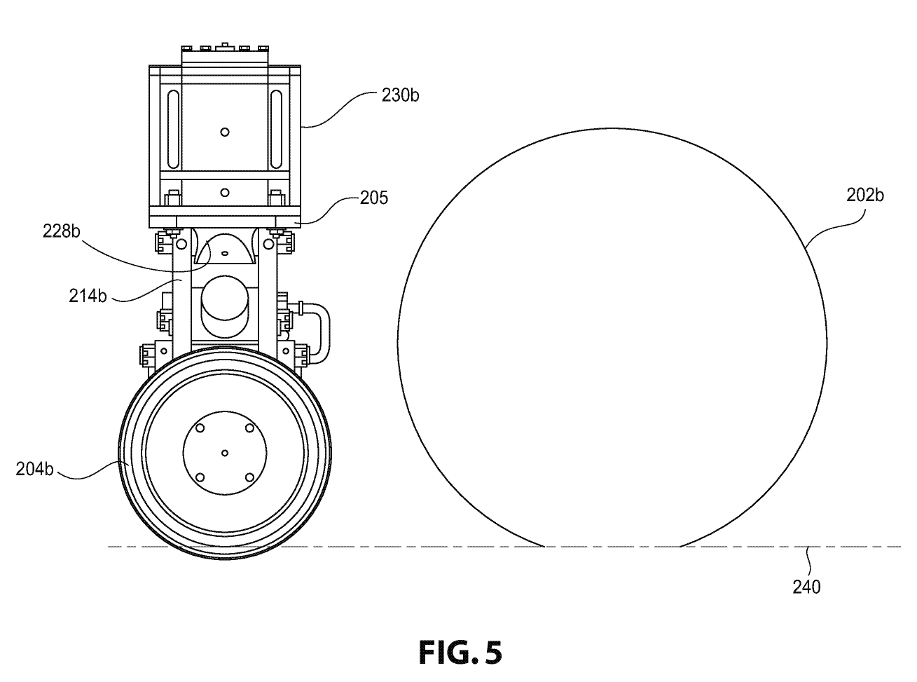

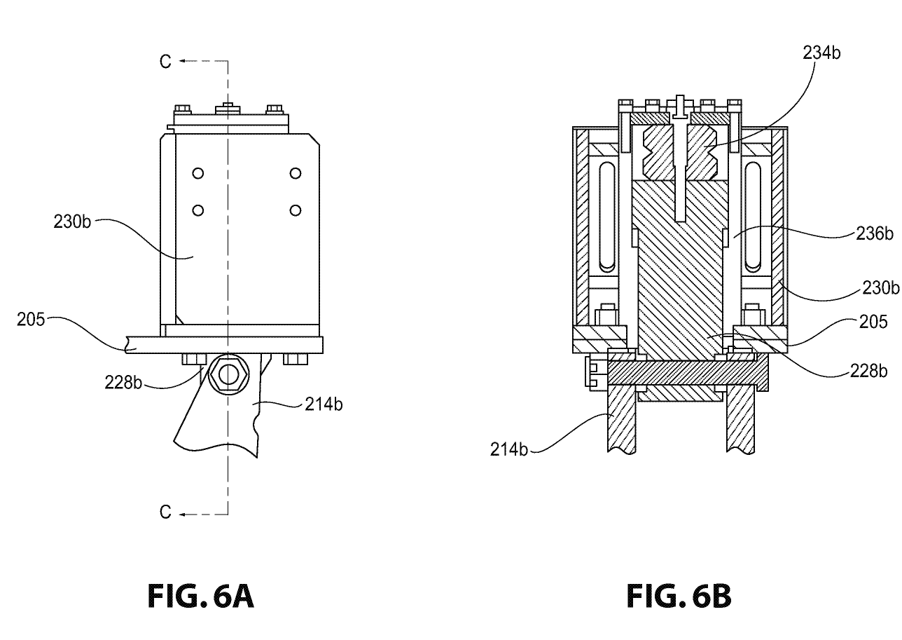

Referring now to FIG. 4, FIG. 5, FIG. 6A, and FIG. 6B, railgear guide unit assembly 200 is shown in a deployed position under “normal” operating conditions, with some reference numerals omitted for clarity. FIG. 4 and FIG. 5 illustrate railgear guide unit assembly 200 in a state where the unit is deployed such that rail wheels 204a, 204b are in contact with respective tracks 206a, 206b and the vehicle tires (such as tire 202b shown in FIG. 5) are travelling normally along the top surface 240 of respective tracks 206a, 206b. During deployment of railgear guide unit assembly 200, rail wheels 204a, 204b are configured to make contact with the top surface 240 of tracks 206a, 206b approximately 1 inch prior to the unit being fully lowered. As the unit continues to be lowered with rail wheels 204a, 204b already in contact with tracks 206a, 206b, inner guides 228a, 228b are forced axially upward into respective outer guide assemblies 236a, 236b. This upward force further compresses the springs contained within respective railgear pressure mechanisms 229a, 229b. For example, as shown in FIG. 6A and FIG. 6B, inner guide 228b is forced upward within outer guide assembly 236b, compressing spring 234b approximately 1 inch as compared to its uncompressed state. In the example shown in FIG. 6B, spring 234b is compressed to a length of approximately 3 3/16 inches, with further upward movement inner guide 228b being limited by contact made between a top surface of upper linkage 214b and a bottom surface of base plate 205. When railgear guide unit assembly 200 is fully lowered, spring 234b will be compressed approximately 2 inches within outer guide assembly 236b. In this way, compressed spring 234b provides a constant downward force of up to 4000 lbs. on rail wheel 204b when assembly 200 is in a deployed position under normal operating conditions.

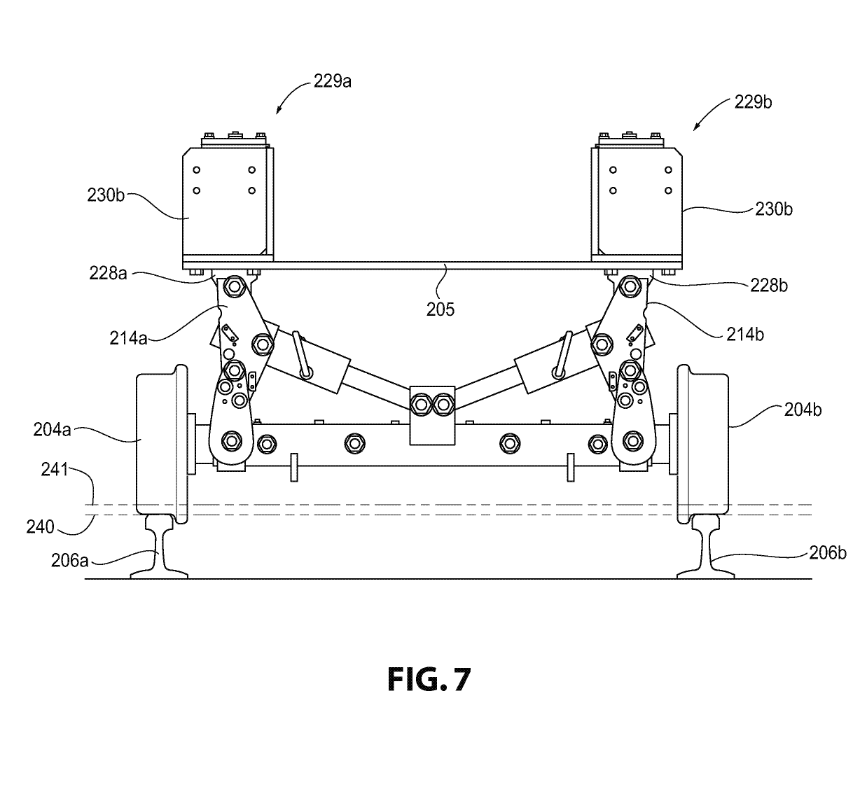

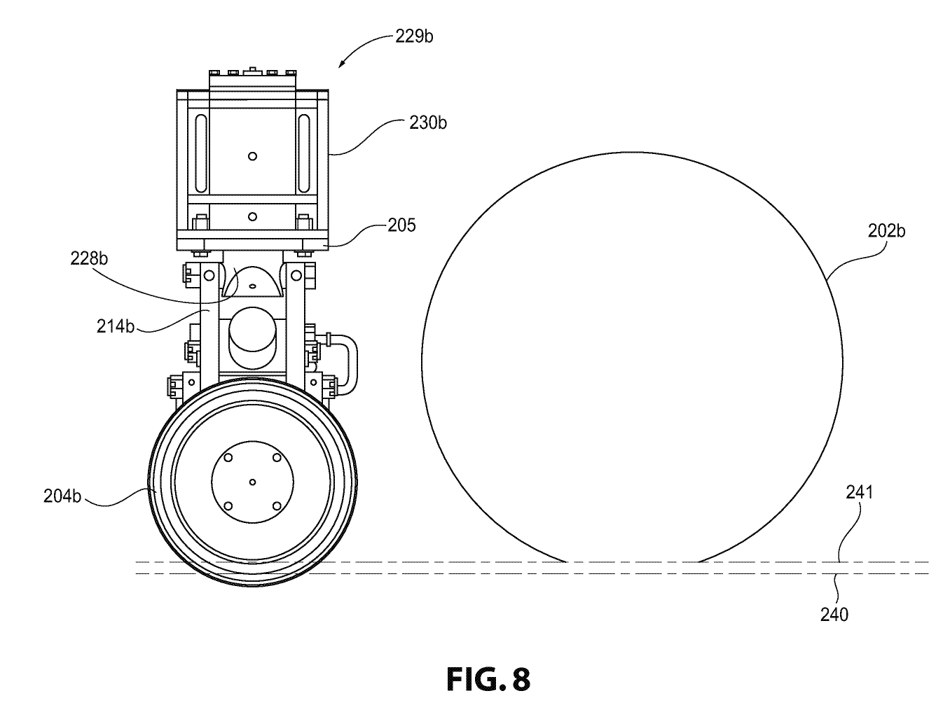

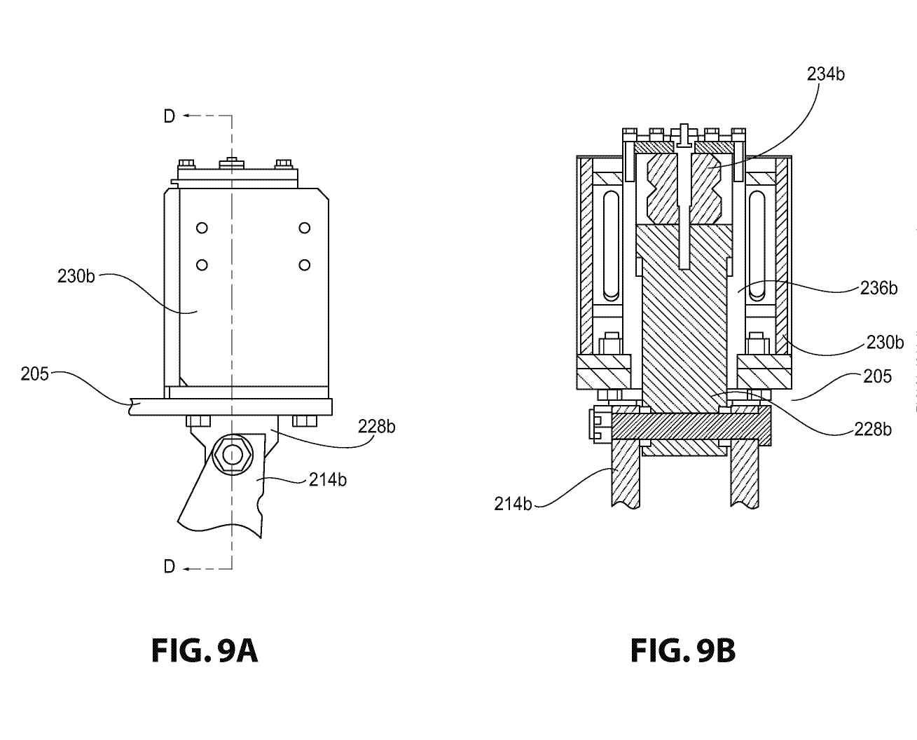

Conversely, FIG. 7, FIG. 8, FIG. 9A, and FIG. 9B illustrate railgear guide unit assembly 200 again in a deployed position, yet under conditions wherein the vehicle tire or tires lift above the normal track surface. As stated above, such conditions may occur when the vehicle moves over railway switches, “frogs”, uneven crossings, or any other object along the rail line that would cause the tires to be lifted above the track surface. Referring to FIG. 7 and FIG. 8, rail wheels 204a, 204b are shown as being in contact with the top surface 240 of respective tracks 206a, 206b, but with respective inner guides 228a, 228b extending a given distance below base plate 205 so as to force rail wheels 204a, 204b into contact with tracks 206a, 206b. As is best shown in FIG. 8, this scenario may occur when one or more of the vehicle tires (such as vehicle tire 202) rises above track surface 240 to a higher surface 241 for any reason.

With conventional railgear guide units, such a rise in vehicle tires above the track surface would likely cause a corresponding rise in the rail wheels away from the track surface, thus increasing the potential for derailment. However, in accordance with the present aspect of the disclosure, respective railgear pressure mechanisms 229a, 229b are configured to force inner guides 228a, 228b downward in the event of a rise in the vehicle tires away from the track surface. More specifically, when a vehicle tire or tires rise above the track surface, the downward force imparted upon the rail wheels by the weight of the vehicle is reduced. As is shown in FIG. 9A and FIG. 9B, this change causes the respective springs of each railgear pressure mechanism, such as spring 234b, to naturally relax and extend, pushing down upon inner guide 228b and resulting in a constant, uniform downward force on the coupled rail wheel. In the example shown in FIG. 9B, spring 234b extends to a length, for example, of 4 3/16 inches, or 1 inch longer than its compressed state under “normal” operating conditions. A 1 inch extension of spring 234b results in a corresponding 1 inch downward travel of both inner guide 228b and the coupled rail wheel (not shown). Downward translation of inner guide 228b within outer guide assembly 236b may be limited, for example, by a ledge surface within outer guide assembly 236b that interacts with a corresponding ledge surface on inner guide 228b. In this state, with a maximum 1 inch difference between the tire tread and the top surface of the rail, a downward force of approximately 1500-2000 lbs. is still exerted on each rail wheel, thereby maintaining a strong interaction between each rail wheel and the track surface.

While the example shown in FIG. 7, FIG. 8, FIG. 9A, and FIG. 9B provide for a maximum travel distance of 1 inch, it is to be understood that the maximum travel distance could be greater or less than 1 inch, dependent upon the type and size of spring used, the restrictions placed upon inner guide travel within the outer guide assembly, etc. Furthermore, the downward force applied to each rail wheel may also vary, again dependent upon the type and size of spring used and the overall travel distance.

Additionally, while the example shown and described above with respect to FIG. 7, FIG. 8, FIG. 9A, and FIG. 9B illustrate a scenario wherein both railgear pressure mechanisms 229a, 229b act in concert to provide the same downward extension of rail wheels 204a, 204b, railgear pressure mechanisms 229a, 229b may also act independently to exert different downward forces upon rail wheels 204a, 204b. For example, there may often be scenarios in which only one vehicle tire rises above the track surface, while the other vehicle tire maintains contact with the track surface. In such a instance, railgear guide unit assembly 200 is configured such that one railgear pressure mechanism, for example mechanism 229a, allows for its inner guide to extend so as to maintain contact with the track surface, while the other railgear pressure mechanism, for example mechanism 229b, does not require extension of its inner guide to maintain sufficient contact with the track surface.

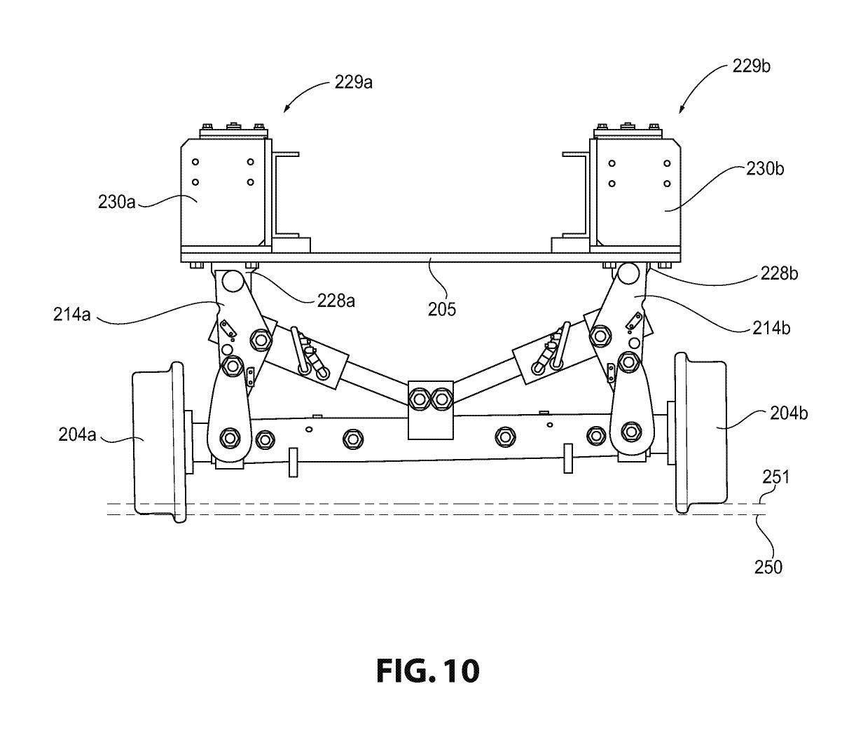

Furthermore, as shown in FIG. 10, railgear guide unit assembly 200 may also account for differences in respective track heights. For example, rail wheel 204a is shown as contacting a track surface at a track height 250, while rail wheel 204b is shown as contacting another track surface at a higher track height 251. Normally, with a fixed railgear guide unit, such variations in track surface height could not be accounted for and one rail wheel might lose contact with the track surface. However, as FIG. 10 shows, one railgear pressure mechanism (for example, mechanism 229a) can provide a downward drop of its inner guide 228a (and hence a downward drop of guide wheel 204a) to account for variations in track surface height.

Although the disclosure has been described in detail for the purpose of illustration based on what are currently considered to be the most practical and preferred aspects, it is to be understood that such detail is solely for that purpose and that the disclosure is not limited to the disclosed aspects, but; on the contrary, is intended to cover modifications and equivalent arrangements. For example, it is to be understood that the present disclosure contemplates that, to the extent possible, one or more features of any aspect can be combined with one or more features of any other aspect.

The invention claimed is:

1. A railgear guide unit assembly for a road vehicle, the assembly comprising:
a base plate for mounting the assembly to at least one frame member of the vehicle;
an axle;
a first rail wheel rotatably mounted on a first end of the axle and a second rail wheel rotatably mounted on a second end of the axle;
a first pair of pivotal links having a first end and a second end, and a second pair of pivotal links having a first end and a second end, wherein the second end of both the first pair of pivotal links and the second pair of pivotal links is pivotally coupled to the axle;
a first railgear pressure mechanism coupled to the base plate, wherein the first railgear pressure mechanism is further coupled to the first end of the first pair of pivotal links and is configured to provide a constant force thereon; and
a second railgear pressure mechanism coupled to the base plate, wherein the second railgear pressure mechanism is further coupled to the first end of the second pair of pivotal links and is configured to provide a constant force thereon.

2. The railgear guide unit assembly of claim 1, wherein each of the first railgear pressure mechanism and the second railgear pressure mechanism comprises:
a housing;
a fixed outer guide assembly within the housing;
a movable inner guide configured for axial translation within the outer guide assembly, the inner guide having a first end and a second end;
a spring coupled to the first end of the inner guide and configured to provide a compressive force on the inner guide; and
wherein the first end of the first pair of pivotal links is pivotally coupled to the second end of the inner guide of the first railgear pressure mechanism, and the first end of the second pair of pivotal links is pivotally coupled to the second end of the inner guide of the second railgear pressure mechanism such that a movement of the inner guide of the first railgear pressure mechanism correponds to a movement of the first pair of pivotal links, and a movement of the inner guide of the second railgear pressure mechanism corresponds to a movement of the second pair of pivotal links.

3. The railgear guide unit assembly of claim 2, wherein the first railgear pressure mechanism and the second railgear pressure mechanism are mounted above the base plate relative to the axle.

4. The railgear guide unit assembly of claim 2, wherein both the inner guide of the first railgear pressure mechanism and the inner guide of the second railgear pressure mechanism extend through the base plate.

5. The railgear guide unit assembly of claim 2, wherein the spring is a rubber spring.

6. The railgear guide unit assembly of claim 2, wherein the first railgear pressure mechanism and the second railgear pressure mechanism each further comprise an outer guide cap mounted to the outer guide assembly.

7. The railgear guide unit assembly of claim 6, wherein the outer guide cap provides compressive force to the spring when mounted on the outer guide assembly.

8. The railgear guide unit assembly of claim 2, wherein a travel distance of the inner guide is physically limited.

9. The railgear guide unit assembly of claim 8, wherein the travel distance of the inner guide is limited by a ledge surface on the outer guide assembly and a corresponding ledge surface on the inner guide.

10. The railgear guide unit assembly of claim 2, wherein the compressive force applied to the inner guide when the spring as at its fullest extension is between approximately 1500 lbs. and 2000 lbs.

11. A method of operating a roadway vehicle on railway tracks, the vehicle having at least a rear pair of roadway tires, the method comprising:
providing a railgear guide unit assembly having a base plate, an axle, a pair of rail wheels, a first pair of pivotal links coupled to the axle at a first end, and a second pair of pivotal links coupled to the axle at a first end;
providing a first railgear pressure mechanism, the first railgear pressure mechanism having a translatable inner guide coupled to a compression spring at a first end thereof and coupled to a second end of the first pair of pivotal links at a second end thereof;
providing a second railgear pressure mechanism, the second railgear pressure mechanism having a translatable inner guide coupled to a compression spring at a first end thereof and coupled to a second end of the second pair of pivotal links at a second end thereof;
attaching the railgear guide unit assembly to the vehicle at a location near the rear pair of tires; and
lowering the pair of rail wheels of the railgear guide unit assembly onto the railway tracks such that the rear pair of tires propel the vehicle.

12. The method of claim 11, further comprising mounting the first railgear pressure mechanism and the second railgear pressure mechanism above the base plate relative to the axle.

13. The method of claim 11, further comprising preloading the compression spring in the first railgear pressure mechanism and preloading the compression spring in the second railgear pressure mechanism.

14. The method of claim 11, further comprising limiting the travel distance of the inner guide within the first railgear pressure mechanism and limiting the travel distance of the inner guide within the second railgear pressure mechanism.

15. A railgear guide unit assembly for a road vehicle, the assembly comprising:
a base plate for mounting the assembly to a vehicle frame;
an axle;
a pair of rail wheels mounted for rotation about opposite ends of the axle;
a first set of pivotal links having a first end and a second end, and a second set of pivotal links having a first end and a second end, wherein the second end of both the first set of pivotal links and the second set of pivotal links is coupled to the axle;
a first railgear pressure mechanism and a second railgear pressure mechanism, wherein each of the first railgear pressure mechanism and the second railgear pressure mechanism comprises:
an outer guide assembly;
an inner guide configured for axial translation within the outer guide assembly, the inner guide having a first end and a second end; and
a spring coupled to the first end of the inner guide and configured to provide a compressive force on the inner guide; and
wherein the first end of the first set of pivotal links is coupled to the second end of the inner guide of the first railgear pressure mechanism, and the first end of the second set of pivotal links is coupled to the second end of the inner guide of the second railgear pressure mechanism.

16. The railgear guide unit assembly of claim 15, wherein both the inner guide of the first railgear pressure mechanism and the inner guide of the second railgear pressure mechanism extend through the base plate.

17. The railgear guide unit assembly of claim 15, wherein the spring is one of a rubber spring and a coil spring.

18. The railgear guide unit assembly of claim 15, wherein a travel distance of the inner guide is physically limited by a surface on the outer guide assembly.

19. The railgear guide unit assembly of claim 15, wherein the compressive force applied to the inner guide when the spring as at its fullest extension is between approximately 1500 lbs. and 2000 lbs.

20. The railgear guide unit assembly of claim 15, wherein the compressive force applied to the inner guide when the spring as at its fullest compression is up to 4000 lbs.
